(19) United States
(12) Patent Application Publication
(10) Pub. No.: US 2025/0310103 A1
(43) Pub. Date: Oct. 2, 2025

(54) LOG VERIFICATION USING KEY ROTATION ENTRIES

(71) Applicant: Dell Products L.P., Round Rock, TX (US)

(72) Inventors: BRADLEY K. GOODMAN, Nashua, NH (US); JOSEPH CAISSE, Burlington, MA (US); ERIC JOSEPH BRUNO, Shirley, NY (US)

(21) Appl. No.: 18/619,675

(22) Filed: Mar. 28, 2024

(51) Int. Cl. H04L 9/14

(52) U.S. Cl. CPC H04L 9/14

(57) ABSTRACT

Methods and systems for managing logs are disclosed. The logs may include any number of log entries and each log entry may be cryptographically signed. The log may include key rotation entries to indicate instances of key rotation events. A key rotation event may result in replacement of a first private key used to sign log entries prior to the key rotation event with a second private key to be used to sign log entries following the key rotation event. A key rotation entry may be back-linked to indicate that the first private key was previously trusted for signing log entries prior to the key rotation event. By utilizing back-linked key rotation entries, all log entries of a lot may be verifiable based on the current key and the key rotation entries. Consequently, a likelihood of an unauthorized entity adding fictitious log entries to a log may be decreased.

### FIELD

Embodiments disclosed herein relate generally to logs. More particularly, embodiments disclosed herein relate to managing logs using key rotation log entries.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2G show data flow diagrams illustrating management of a log in accordance with an embodiment.

FIG. 3A shows a flow diagram illustrating a method of managing a log in accordance with an embodiment.

FIG. 3B shows a flow diagram illustrating a method of verifying digital signatures of log entries of a log in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing logs. A log may include any number of log entries and the log entries may be accessed for use in providing computer-implemented services. For example, the log entries may include operational information for one or more devices throughout a distributed environment.

Unauthorized entities may attempt to modify and/or otherwise compromise the log to manipulate the computer-implemented services. To prevent modifications to the log by unauthorized entities, each log entry of the log may be cryptographically signed.

Keys used to cryptographically sign the log entries may be rotated over time to reduce a likelihood of compromise of the keys by unauthorized entities (e.g., a first public private key pair may be replaced with a second public private key pair).

Prior to use of the information included in the log entries, an entity may verify signatures of the log entries. Log entries added to the log following the key rotation event (e.g., signed using a second private key of the second public private key pair) may be verified using a second public key of the second public private key pair.

However, log entries added prior to the key rotation entry (e.g., signed using a first private key of the first public private key pair) may be un-verifiable due to a lack of secure knowledge of the first public private key pair.

To manage a log so that log entries added prior to a key rotation event are verifiable, key rotation entries may be added to the log when key rotation events occur. A key rotation entry may indicate that a first public key (e.g., of the first public private key pair being replaced) was a designated key prior to the key rotation event for signing log entries and may be signed using the second private key. By doing so, all log entries in the log may be verifiable using a currently trusted public key (e.g., the second public key) and the key rotation entry.

Thus, embodiments disclosed herein may address, among other technical problems, the technical problem of security of logs that rely on cryptographic verification such as signatures. Because signatures may only provide security when the keys and processes used in the signing remain secure, even a cryptographically signed data structure may still be untrustworthy. To address this technical problem, embodiments disclosed herein may facilitate verification of log entries before and after key rotation events thereby a likelihood of successful verification of logs.

In an embodiment, a method of managing a log including a plurality of log entries is provided. The method may include: making a first identification that the log is to be cryptographically verified, the log comprising: a first set of log entries added to the log at a first point in time and signed with a first key; a key rotation entry signed using a second key and indicating replacement of the first key with the second key for log security purposes; and a second set of log entries added to the log at a second point in time and signed with the second key, the second point in time being after the first point in time; verifying, in response to the first identification and using the second key, the log to obtain a verified log; and providing computer-implemented services using the verified log.

The method may also include: prior to making the identification: making a second identification that a key rotation event has occurred for the log, the key rotation event indicating that the second key is to replace the first key and log entries added to the log at future points in time after the key rotation event are to be signed using the second key; obtaining, in response to the second identification, the key rotation entry, the key rotation entry comprising: a payload identifying the first key to indicate that the first key was a designated key prior to the key rotation event for signing the first set of log entries; and a signature generated using the second key; and adding the key rotation entry to the log.

The method may also include: obtaining a new log entry and signing the new log entry with the second key; and adding the signed new log entry to the second set of the log entries.

The first key may be a first private key of a first public private key pair and the second key may be a second private key of a second public private key pair.

The second set of the log entries may be verifiable using a second public key of the second public private key pair and the first set of the log entries may be verifiable using a first public key of the first public private key pair.

Verifying the log may include: verifying, using the second public key, that each log entry of the second set of the log entries is signed using the second private key of the second public private key pair; verifying, using the second public key, that the key rotation entry is signed using the second private key; obtaining the first public key from the payload of the key rotation entry; and verifying, using the first public key, that each log entry of the first set of the log entries is signed using the first private key of the first public private key pair.

The log may be truncated so that a portion of the log is removed.

The removed portion of the log may include: one or more log entries of the first set of the log entries.

All log entries of the truncated log may be verifiable based on the second key and the key rotation entry.

The first public key may not be known prior to verifying the log and using the key rotation entry.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

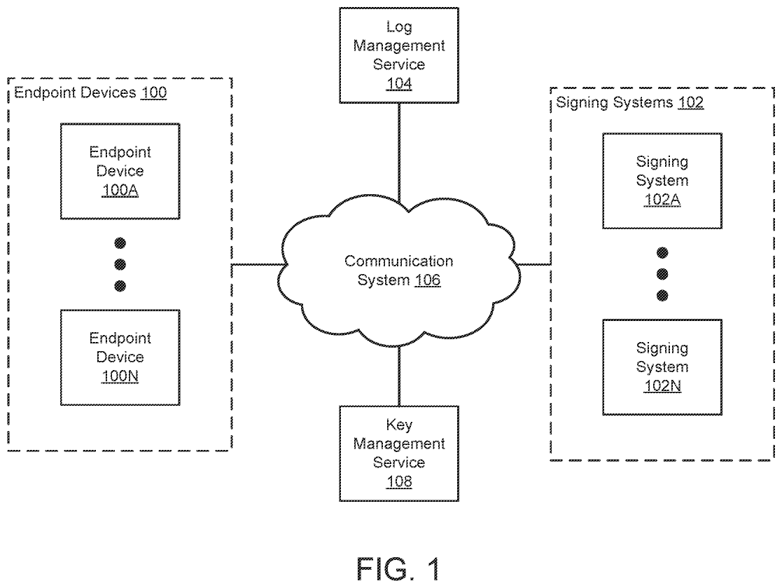

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, and/or any other type of service that may be implemented with a computing device.

The computer-implemented services may be provided by one or more components of the system of FIG. 1. For example, an endpoint device (e.g., 100A) of endpoint devices 100 may provide a portion of the computer-implemented services.

Over time, endpoint device 100A may collect operational data related to performance of hardware and/or software components of endpoint device 100A. Specifically, the operational data may include current statistics related to hardware and/or software components of endpoint device 100A, errors encountered by endpoint device 100A during operation, actions performed by endpoint device 100A, etc. The operational data may be collected over a duration of time (e.g., one day) and may be compiled into a log entry.

The log entry may be provided to an entity responsible for managing and storing log entries. The log entry may be provided to another device throughout the distributed system (e.g., log management service 104) for storage, may be stored by endpoint device 100A itself, and/or may be stored by any other entity throughout the distributed environment.

The entity responsible for managing the log entries may add the log entry to a log, the log including any number of log entries. For example, one log may be managed for each of endpoint devices 100, one log may be managed for different types of data obtained from each of endpoint devices 100, etc.

To increase security of the log, each log entry may be cryptographically signed. Each log entry may be cryptographically signed using a private key of a trusted public private key pair and may be verified by any entity in possession of a public key of the trusted public private key pair. Log entries may be signed by: (i) endpoint devices 100 following generation of a log entry, (ii) by any of signing systems 102 via interactions with endpoint devices 100, (iii) by log management service 104 upon receipt of the log entries, and/or (iv) by another entity.

To provide computer-implemented services using the logs, an entity may desire each log entry in the log to be verified (e.g., by verifying a digital signature using the public key). The entity may wish to utilize information included in the log to perform a de-bugging process for one or more of endpoint devices 100, to service one or more of endpoint devices 100, to validate one or more processes performed by endpoint devices 100, etc.

However, keys used to generate digital signatures for the log entries may be rotated over time for any reason. For example, key rotation may be initiated by an entity (e.g., key management service 108) according to a key rotation schedule, in response to potential compromise of one or more keys, upon request from a user, and/or for other reasons.

For example, following a key rotation event, a first private key of a first public private key pair may no longer be used to sign log entries for the log. A second private key of a second public private key pair may be used to sign any future log entries to be added to the log.

Therefore, the log may include a first set of log entries signed using the first key (e.g., the first private key) and a second set of log entries signed using the second key (e.g., the second private key). An entity attempting to verify each log entry may verify, using the second public key, that each log entry of the second set of the log entries was signed using the second private key.

To differentiate between the first set of the log entries and the second set of the log entries, a key rotation entry may be added to the log. The key rotation entry may indicate that a first public key of the first public private key pair is no longer to be used to verify log entries added at points in time after the key rotation entry is added to the log and that a second public key of the second public private key pair is to be used to verify the log entries added at the points in time after the key rotation entry is added to the log.

However, the first set of the log entries may no longer be verifiable. For example, the first set of the log entries may be un-verifiable based on a lack of secure knowledge of the first public private key pair.

In addition, the log may be truncated over time (e.g., one or more of the log entries may be removed from the log) to conserve storage resources of a device and/or for other purposes. If the log is truncated, key rotation entries may be missing and/or may not be traceable to the beginning of the log.

Specifically, an unauthorized entity may utilize truncation of a log as a means of inserting fictitious log entries into the log. To do so, the unauthorized entity may generate a fictitious key rotation entry indicating, for example, that a first fictitious key is replaced by the second (trusted) key.

By doing so, the fictitious log entries may be indistinguishable from genuine log entries and the truncated log may lead to the fictitious key rotation entry appearing genuine, as the chain of key rotations may not be traceable beyond where the log is truncated.

In general, embodiments disclosed herein may provide methods, systems, and/or devices for managing logs using back-linked key rotation entries. When a key rotation event occurs (e.g., the first key replaced with the second key), a back-linked key rotation entry may be added to the log. The back-linked key rotation entry may include the first public key (e.g., corresponding to the first private key used to sign the first set of the log entries) to indicate that the first private key was a designated key prior to the key rotation event for signing log entries. The back-linked key rotation entry may be signed by the second private key (e.g., the second key used to sign the second set of the log entries).

Therefore, verifying the log may include: (i) verifying, using the second public key, that each log entry of the second set of the log entries is signed using the second private key of the second public private key pair, (ii) verifying, using the second public key, that the key rotation entry (e.g., the back-linked key rotation entry) is signed using the second private key, (iii) obtaining the first public key from the payload of the key rotation entry, (iv) and/or verifying, using the first public key, that each log entry of the first set of the log entries is signed using the first private key of the first public private key pair.

To provide the above noted functionality, the system of FIG. 1 may include any number of endpoint devices 100, signing systems 102, log management service 104 and/or key management service 108. Each of these components may be separate devices and/or may be combined into a single device. Each of these components is discussed below.

Signing systems 102 may be data processing systems usable to sign log entries. To do so, each of signing systems 102 may include functionality to (i) obtain a log entry (and/or components of the log entry), (ii) cryptographically sign (e.g., using a trusted private key) the log entry, and/or (iii) provide the signed log entry to an entity responsible for adding the log entry to a log for storage purposes (e.g., log management service 104).

Endpoint devices 100 may provide computer-implemented services by generating log entries. To perform their functionality, endpoint devices 100 may: (i) generate a log entry, the log entry including any amount of operational data, diagnostic data, and/or other data related to endpoint devices 100, and/or (ii) provide the log entry to an entity responsible for signing and/or storing the log entries as part of a log. Endpoint devices 100 may also be responsible for signing and storing the log entries.

Log management service 104 may be any device responsible for storing logs, managing logs, verifying logs, etc. To perform its functionality, log management service 104 may receive log entries (e.g., from endpoint devices 100, from signing systems 102) and may store the log entries as part of a log. The log entries may be signed upon receipt of the log entries and/or may be signed by log management service 104 prior to adding the log entries to the log. Log management service 104 may verify digital signatures of any number of log entries and/or may provide signed log entries to other entities responsible for verifying the digital signatures.

Key management service 108 may be any entity responsible for managing secure keys throughout the distributed environment. To perform its functionality, key management service 108 may: (i) provide public keys to entities responsible for verifying digital signatures, (ii) provide private keys to signing systems 102 and/or other entities that may be signing log entries (via a secure communication to a TPM, etc.), (iii) initiate key rotation events as needed, and/or (iv) may manage key rotation events by providing updated public and private keys to entities throughout the distributed environment.

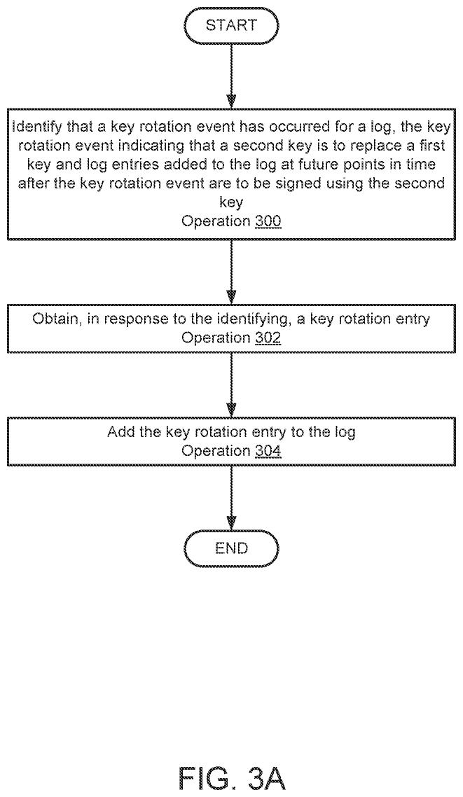

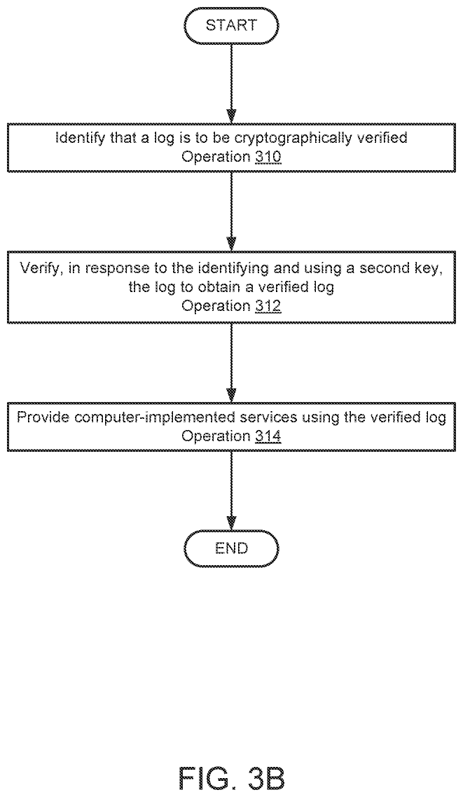

When providing their functionality, any of (and/or components thereof) signing systems 102, endpoint devices 100, log management service 104, and/or key management service 108 may perform all, or a portion, of the methods illustrated in FIGS. 3A-3B.

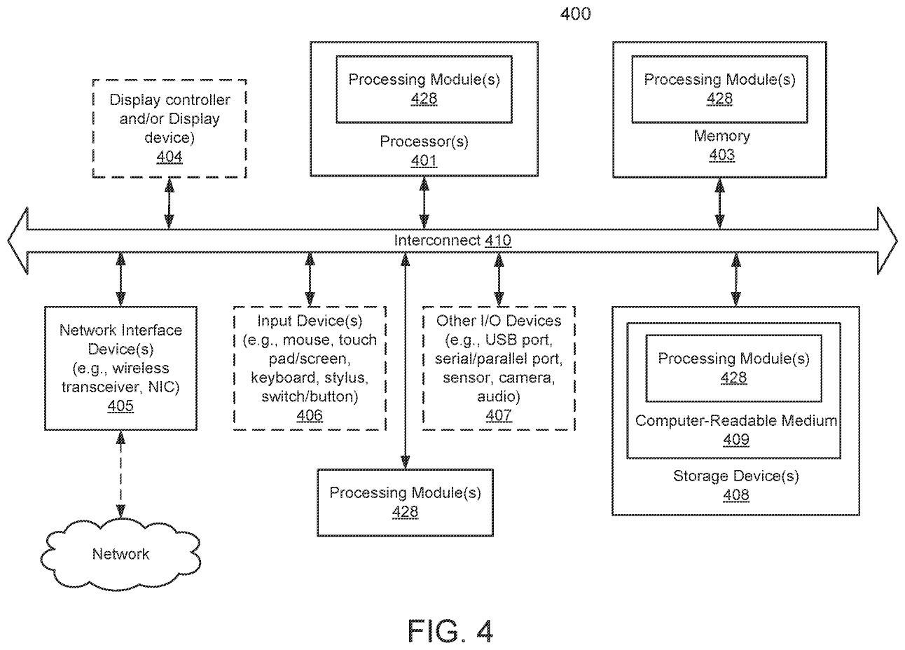

Any of (and/or components thereof) signing systems 102, endpoint devices 100, signing systems 102, and log management service 104, and key management service 108 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106.

In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those components illustrated therein.

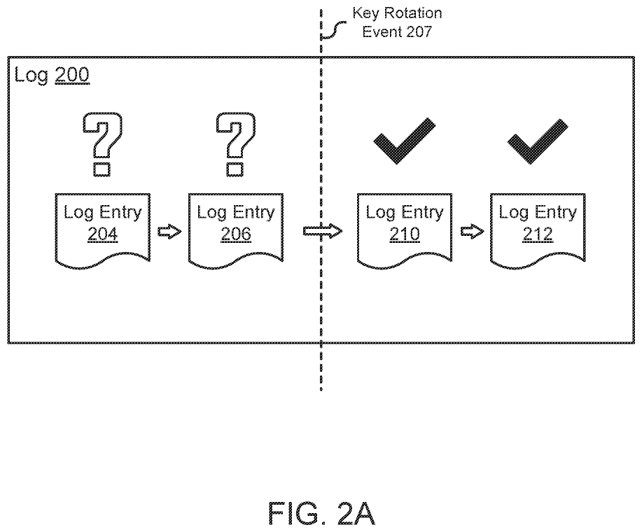

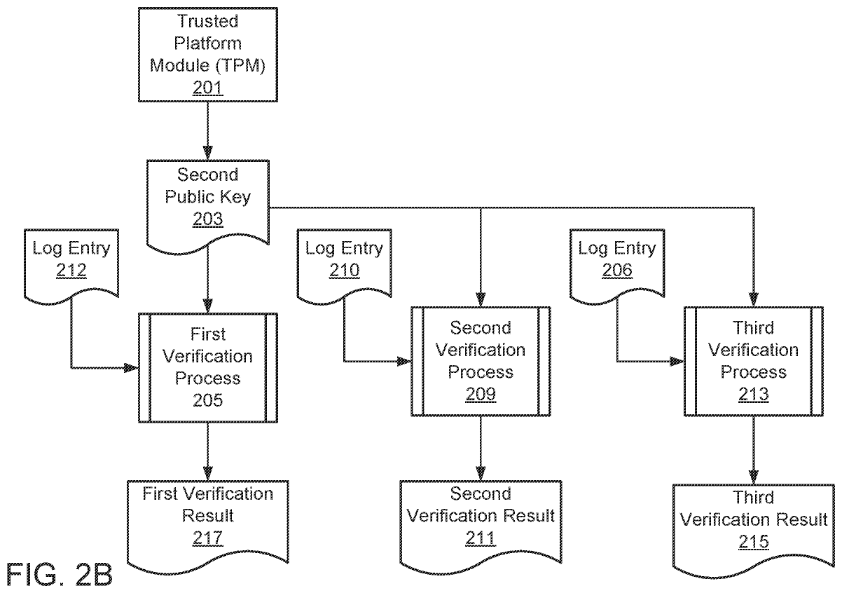

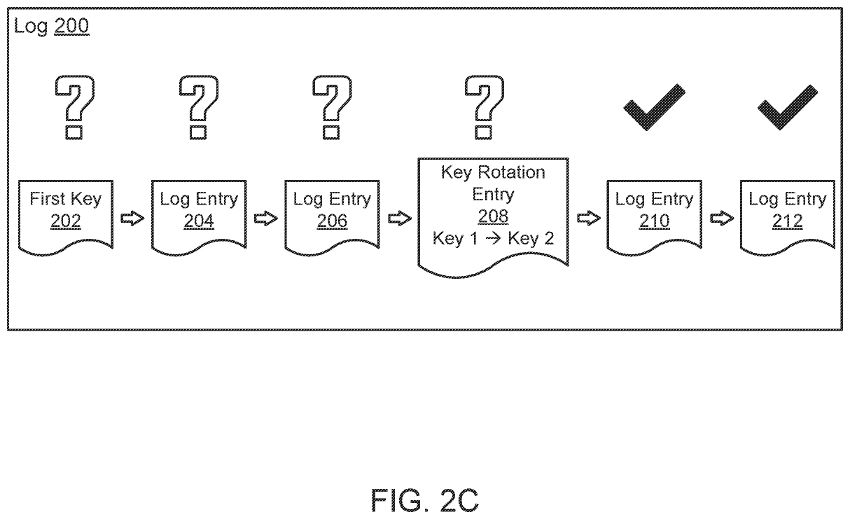

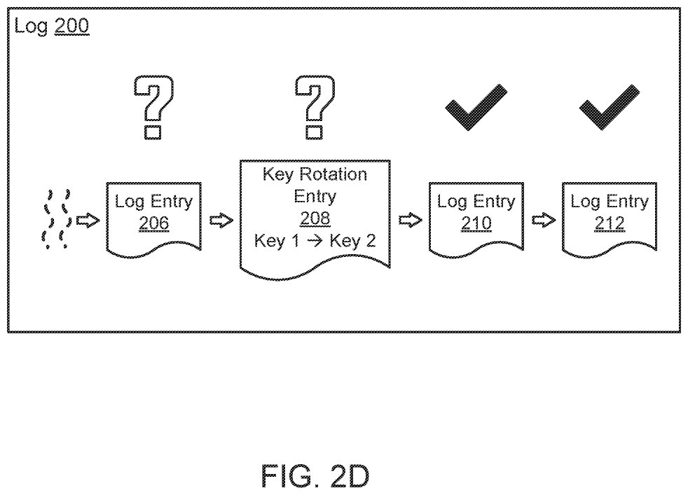

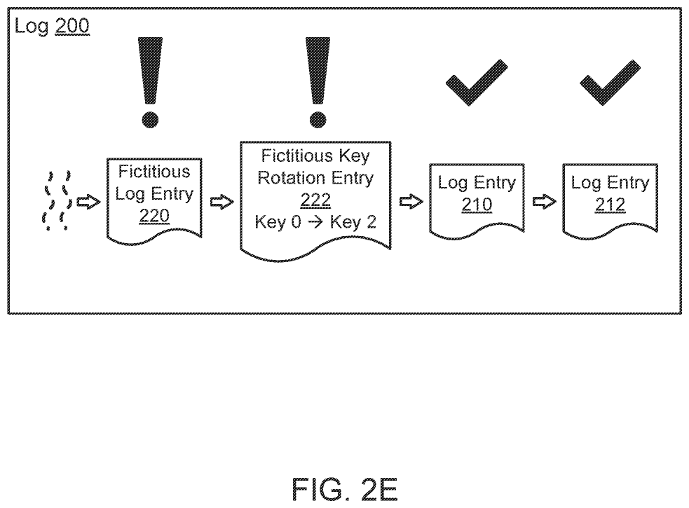

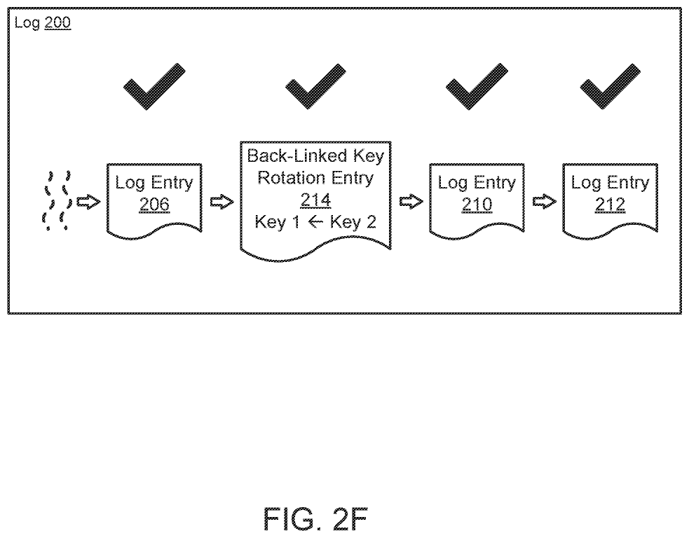

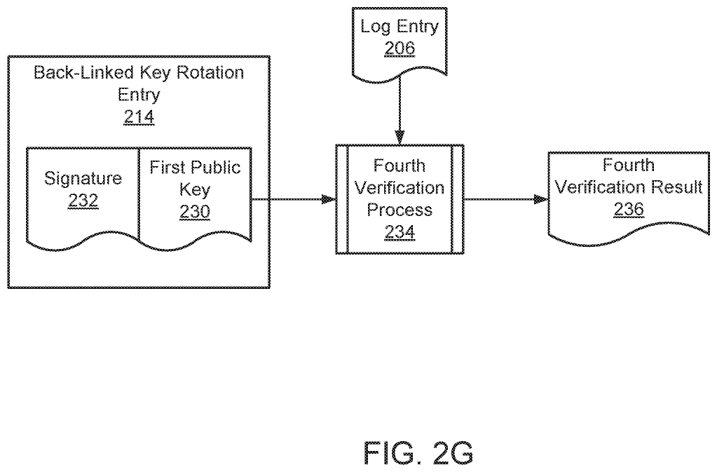

To further clarify embodiments disclosed herein, data flow diagrams in accordance with an embodiment are shown in FIGS. 2A-2G. In these diagrams, flows of data and processing of data are illustrated using different sets of shapes. A first set of shapes (e.g., 204, 206, etc.) is used to represent data structures and a second set of shapes (e.g., 205, 209, etc.) is used to represent processes performed using and/or that generate data.

Turning to FIG. 2A, a first data flow diagram in accordance with an embodiment is shown. Consider a scenario in which log 200 includes a chain of log entries (e.g., 204, 206, 210, 212). Each log entry of the chain of the log entries may be added in temporal order (e.g., an order in which they are received, an order according to timestamps associated with the log entries) to log 200. Log 200 may be managed by an entity similar to log management service 104 described in FIG. 1.

Log entry 204 and log entry 206 may be part of a first set of log entries and may be signed using a first private key of a first public private key pair. At a point in time between addition of log entry 206 and addition of log entry 210 to log 200, key rotation event 207 may occur. Key rotation event 207 may indicate that the first private key is no longer in use to sign log entries for log 200 and that a second private key is to be used to sign future log entries.

Therefore, log entry 210 and log entry 212 may be part of a second set of log entries and may be signed using the second private key. As the first private key has aged out (e.g., as indicated by key rotation event 207), an entity attempting to verify digital signatures for log entries of log 200 may only be able to verify digital signatures of log entry 210 and log entry 212 using a second public key (e.g., of a second public private key pair corresponding to the second private key). This is indicated in FIG. 2A by the check marks above log entries 210 and 212 (e.g., successful verification) and the question marks above log entries 204 and 206 (e.g., unsuccessful verification).

Turning to FIG. 2B, a second data flow diagram in accordance with an embodiment is shown. FIG. 2B displays data flow during attempted verification of log entries of log 200 shown in FIG. 2A. An entity attempting to verify log entries of log 200 (e.g., a service technician utilizing a device, a de-bugging agent, a device performing a verification process) may obtain second public key 203. Second public key 203 may be a currently trusted public key (e.g., the second public key of the second public private key pair described with respect to key rotation event 207).

The entity may obtain second public key 203 from, for example, a trusted platform module (TPM) of a device (e.g., TPM 201). TPM may obtain second public key 203 by generating second public key 203, through secure communications with an entity with authority over keys throughout the distributed environment, and/or via other secure methods.

Second public key 203 may be used to perform first verification process 205. First verification process 205 may include verifying that log entry 212 was signed using the second private key by an authorized entity using the second public key via any key verification algorithm.

First verification process 205 may include generating first verification result 217. First verification result 217 may indicate that second public key 203 was used successfully to verify the digital signature included in log entry 212.

To attempt to verify a digital signature included in log entry 210, second verification process 209 may be performed. Second verification process 209 may be similar to first verification process 205 and may include using the second public key of second public key 203 to verify that log entry 210 was signed using the second private key by an authorized entity.

Second verification process 209 may include generating second verification result 211. Second verification result 211 may indicate that second public key 203 was used successfully to verify the digital signature included in log entry 210.

To attempt to verify a digital signature included in log entry 206, third verification process 213 may be performed. Third verification process 213 may be similar to first verification process 205 and second verification process 209 and may include using the second public key of second public key 203 to verify that log entry 206 was signed using the second private key by an authorized entity.

Third verification process 213 may include generating third verification result 215. As log entry 206 was added to log 200 prior to key rotation event 207, third verification result 215 may indicate that second public key 203 was not used successfully to verify the digital signature included in log entry 206. The entity attempting to verify the log entries may not have secure knowledge of the first public private key pair and, therefore, may be unable to verify log entry 206 (and/or any previously added log entries such as log entry 204).

Consequently, data included in log entry 206 and log entry 204 may not be trustworthy for use by entities throughout the distributed environment and may negatively impact an availability and/or reliability of computer-implemented services based on the data.

Turning to FIG. 2C, a third data flow diagram in accordance with an embodiment is shown. The third data flow diagram may illustrate log 200 with the addition of first key 202 and key rotation entry 208 to attempt to track rotation of keys used to sign log entries of log 200.

Specifically, upon formation of log 200, first key 202 may have been added to indicate a public key corresponding to a private key that will be used to sign log entries (e.g., the first private key). First key 202 may be a cryptographically signed data structure including a payload. The payload may include the first public key. The first public key may correspond to a first private key of the first public private key pair that may be used to sign log entries of log 200 (e.g., the first set of the log entries). First key 202 may be signed using a third private key (e.g., a private key that is different from the first private key) and the third private key may be a private key maintained by a trusted entity (e.g., a manufacturer of endpoint devices that provide the log entries).

Key rotation entry 208 may include the second public key and a statement delegating authority (e.g., for signing log entries) to the second private key from the first private key. By doing so, key rotation entry 208 may indicate that future log entries added to log 200 may be signed using the second private key. Key rotation entry 208 may be signed using the first private key. Therefore, the first public key may be used to verify that key rotation entry 208 was generated by an entity in possession of the first private key.

Verification of digital signatures of log entries 210 and 212 may include processes and interactions similar to those described in FIG. 2B. However, a digital signature of key rotation entry 208 may be verified using the first public key, which may have aged out (e.g., may no longer be trustworthy due to a duration of time passing, due to compromise of the first private key).

In addition, first key 202 may be verified using a third public key of a third public private key pair (e.g., a public key corresponding to the third private key used to sign first key 202). However, this may require the entity attempting to verify digital signatures of log entries of log 200 to have previously established trust with an entity that signed first key 202, etc.

In summary, the entity attempting to verify digital signatures of log entries of log 200 may be able to identify keys that were used over time to sign log entries of log 200 due to the inclusion of first key 202 and key rotation entry 208. However, the third key and the first key may no longer be trusted and/or available for any reason. Therefore, only log entry 210 and log entry 212 may be successfully verified.

Turning to FIG. 2D, a fourth data flow diagram in accordance with an embodiment is shown. In FIG. 2D, log 200 may be stored by an entity with limited storage capacity. To conserve storage resources, the entity responsible for storing and/or managing log 200 may truncate (e.g., reduce the size of) log 200 as indicated in FIG. 2D by the dashed lines at the left side of the figure.

Truncating log 200 may remove one or more log entries from the first set of the log entries (e.g., first key 202 and log entry 204 shown in FIG. 2C). As the sequence of keys used to sign log entries is no longer traceable back to the beginning of log 200 (e.g., via the removal of first key 202), an entity attempting to verify digital signatures of log entries may be unable to verify digital signatures of log entry 206 and key rotation entry 208.

Truncating log 200 may also make log 200 vulnerable to manipulation by an unauthorized entity. Turning to FIG. 2E, a fifth data flow diagram in accordance with an embodiment is shown. FIG. 2E shows a scenario in which an unauthorized entity has added fictitious log entry 220 and fictitious key rotation entry 222 to log 200.

Fictitious log entry 220 may be signed using a fourth key (e.g., an unauthorized key, a key maintained by the unauthorized entity) and may include data intended to manipulate computer-implemented services provided based on data included in log 200. Fictitious key rotation entry 222 may indicate that the fourth key (designated as ‘key 0’ in fictitious key rotation entry 222) was replaced by the second key and, therefore, fictitious log entry 220 is a valid entry in log 200 prior to the key rotation event and the addition of log entry 210 and log entry 212.

An entity attempting to verify digital signatures of log entries may not be able to differentiate between genuine and fictitious log entries and/or key rotation entries. Key rotation entry 208 (in FIG. 2D) and fictitious key rotation entry 222 (shown in FIG. 2E) may contain similar types of information and may be signed using keys that are not traced to the beginning of log 200, thereby increasing a cognitive and/or computational load on the entity attempting to verify digital signatures of log entries.

Turning to FIG. 2F, a sixth data flow diagram in accordance with an embodiment is shown. In FIG. 2F, key rotation entry 208 is replaced by back-linked key rotation entry 214. Back-linked key rotation entry 214 may signify occurrence of a key rotation event (e.g., 207 described in FIG. 2A) similarly to key rotation entry 208. However, unlike key rotation entry 208, back-linked key rotation entry 214 may include the first public key as a payload and may be signed using the second private key (e.g., the most current trusted key). Therefore, regardless of whether log 200 is truncated, an entity attempting to verify digital signatures of log 200 may utilize the second public key to verify a digital signature of back-linked key rotation entry 214 and may obtain the first public key from the payload of back-linked key rotation entry 214.

By doing so, an entity with authority to sign log entries (e.g., an entity maintaining the second private key) may indicate that the first private key was a trusted key for signing log entries prior to key rotation event 207. Inclusion of a back-linked key rotation entry may, therefore, reduce a likelihood that an unauthorized entity may insert fictitious log entries into log 200.

The first public key obtained from the payload of back-linked key rotation entry 214 may then be used to verify a digital signature of log entry 206. Turning to FIG. 2G, a seventh data flow diagram in accordance with an embodiment is shown. FIG. 2G shows data flow during an attempt to verify a digital signature of log entry 206 using back-linked key rotation entry 214.

As described in FIG. 2F, back-linked key rotation entry 214 may include a payload (e.g., first public key 230) and may be cryptographically signed using the second private key (e.g., signature 232).

Signature 232 may be verified using the second public key to verify that back-linked key rotation entry 214 was signed using the second private key (not shown).

To verify a digital signature of log entry 206, fourth verification process 234 may be performed. Fourth verification process 234 may include utilizing first public key 230 to verify that log entry 206 was signed using the first private key (e.g., via methods similar to those described with respect to first verification process 205 in FIG. 2B).

Fourth verification process 234 may include generating fourth verification result 236. Fourth verification result 236 may indicate that first public key 230 was used successfully to verify the digital signature included in log entry 206.

Therefore, by including back-linked key rotation entries in a log to represent instances of key rotation events, each log entry of a log may be verified using the most current key and the back-linked key rotation entries.

While described in FIGS. 2A-2G as including up to four log entries, it may be appreciated that logs may include any number of log entries and key rotation entries (e.g., representing any number of key rotation events) without departing from embodiments disclosed herein.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to verify digital signatures of log entries of logs. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing a log in accordance with an embodiment is shown. The method may be performed by an endpoint device, a signing system, a log management service, a key management service, and/or any other entity.

A log may include any number of log entries. Each log entry added to the log may be cryptographically signed using a private key of a public private key pair. Over time, keys (e.g., of public private key pairs used to sign log entries) may be rotated to increase security throughout a distributed environment, etc.

At operation 300, it may be identified that a key rotation event has occurred for a log, the key rotation event indicating that a second key is to replace a first key and log entries added to the log at future points in time after the key rotation event are to be signed using the second key. The second key may be a second private key of a second public private key pair and the first key may be a first private key of a first public private key pair.

Identifying that the key rotation event has occurred may include: (i) receiving a notification (e.g., via a message over a communication system) indicating that the key rotation event has occurred, (ii) reading a key rotation schedule from storage, the key rotation schedule indicating that a key rotation event is scheduled to occur, (iii) receiving a log entry for addition to the log, the log entry including an indicator that the log entry was signed using the second key (e.g., the second private key), and/or (iv) other methods.

At operation 302, a key rotation entry may be obtained in response to identifying the key rotation event. Obtaining the key rotation entry may include: (i) generating the key rotation entry, (ii) reading the key rotation entry from storage, (iii) receiving (e.g., via a message over a communication system) the key rotation entry from another entity, and/or (iv) other methods.

Generating the key rotation entry may include: (i) obtaining the first public key and a statement indicating that the first key (e.g., the first private key corresponding to the first public key) was a designated key prior to the key rotation event for signing a first set of log entries of the log, and/or (ii) signing, using a second private key of the second public private key pair, the identifier and the statement.

At operation 304, the key rotation entry may be added to the log. Adding the key rotation entry to the log may include: (i) signing the key rotation log entry (if not already signed) using the second private key of the second public private key pair, (ii) generating supplementary data for the key rotation entry (e.g., including, for example, a timestamp indicating when the key rotation entry was added to the log, (iv) storing the key rotation entry and/or the supplementary information in the log via performance of a storage procedure, and/or (v) other methods.

The method may end following operation 304.

After adding the key rotation entry to the log, a new log entry may be obtained. The new log entry may be signed with the second key and added to a second set of log entries of the log. The second set of the log entries may include any number of log entries signed using the second key (e.g., the second private key of the second public private key pair).

Obtaining the new log entry may include: (i) generating the new log entry (e.g., via data collection, data aggregation, device diagnostics), (ii) reading the new log entry from storage, (iii) receiving the new log entry in the form of a message from another entity throughout a distributed environment, and/or (iv) other methods.

Signing the new log entry with the second key may include generating cryptographic information using a payload (e.g., the new log entry) and the second private key (e.g., a hash of the payload and the second private key) and/or other methods.

Adding the new log entry to the second set of the log entries may include: (i) storing the new log entry (e.g., along with any supplementary information such as a timestamp) in the log via performance of a storage procedure, (ii) providing the new log entry to another entity responsible for storing the new log entry in the log, and/or (iii) other methods.

Thus, key rotation events may be documented throughout the log as they occur. Key rotation entries may be back-linked key rotation entries. A back-linked key rotation entry may include a verifiable data structure indicating which key was a previously trusted key for signing log entries. By including back-linked key rotation entries in the log, an entity attempting to verify the log may have trusted knowledge of which keys have been trusted in the past to sign log entries. Consequently, a likelihood of an unauthorized entity compromising at least a portion of the log may be decreased.

Turning to FIG. 3B, a flow diagram illustrating a method of verifying digital signatures of log entries of a log in accordance with an embodiment is shown. The method may be performed by an endpoint device, a signing system, a log management service, a key management service, and/or any other entity.

At operation 310, it may be identified that the log is to be cryptographically verified. Identifying that the log is to be cryptographically verified may include: (i) receiving a request to verify the log (e.g., verify digital signatures of log entries of the log) from another entity, (ii) reading a request to verify the log from storage (e.g., based on a recurring schedule for log verification, in response to an event), (iii) generating a request to verify the log, and/or (iv) other methods.

For example, a request to verify the log may be received from a device (e.g., a user device) and the user of the user device may be a service technician. The service technician may request verification of the log as part of servicing an endpoint device from which the log is generated (e.g., the log may include diagnostic and/or otherwise operational data related to the endpoint device).

At operation 312, the log may be verified, in response to the identifying and using the second key, to obtain a verified log. Verifying the log may include: (i) verifying, using the second public key, that each log entry of the second set of the log entries is signed using the second private key of the second public private key pair, (ii) verifying, using the second public key, that the key rotation entry is signed using the second private key, (iii) obtaining the first public key from the payload of the key rotation entry, and (iv) verifying, using the first public key, that each log entry of the first set of the log entries is signed using the first private key of the first public private key pair.

Verifying that each log entry of the second set of the log entries is signed using the second private key may include: (i) decrypting, using the second public key, the digital signature, (ii) generating a hash of the payload (e.g., the log entry), (iii) comparing the decrypted digital signature to the hashed payload, and/or (iv) via any other key pair verification process. Verifying that each log entry of the second set of the log entries is signed using the second private key may also include providing the second public key and the second set of the log entries to another entity responsible for verifying log entries.

Verifying that the key rotation entry is signed using the second private key may include methods similar to those described above with respect to verifying the second set of the log entries.

Obtaining the first public key may include: (ii) reading the first public key from the payload of the key rotation entry, (ii) querying another entity for the first public key and receiving the first public key in response to the querying, and/or (iii) other methods.

Verifying that each log entry of the first set of the log entries is signed using the first private key may include: (i) decrypting, using the first public key, the digital signature, (ii) generating a hash of the payload (e.g., the log entry), (iii) comparing the decrypted digital signature to the hashed payload, and/or (iv) via any other key pair verification process. Verifying that each log entry of the first set of the log entries is signed using the first private key may also include providing the first public key and the first set of the log entries to another entity responsible for verifying log entries.

At operation 314, computer-implemented services may be provided using the verified log. Providing the computer-implemented services may include: (i) providing the verified log to an entity for use in servicing an endpoint device, (ii) feeding the log into an inference model to generate inferences, (iii) performing a data analysis process using the log, and/or (iv) other methods.

The method may end following operation 314.

Any of the components illustrated in FIGS. 1-2G may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing a log comprising a plurality of log entries, the method comprising:
making a first identification that the log is to be cryptographically verified, the log comprising:
a first set of log entries added to the log at a first point in time and signed with a first key;
a key rotation entry signed using a second key and indicating replacement of the first key with the second key for log security purposes; and
a second set of log entries added to the log at a second point in time and signed with the second key, the second point in time being after the first point in time;
verifying, in response to the first identification and using the second key, the log to obtain a verified log; and
providing computer-implemented services using the verified log.

2. The method of claim 1, further comprising:
prior to making the identification:
making a second identification that a key rotation event has occurred for the log, the key rotation event indicating that the second key is to replace the first key and log entries added to the log at future points in time after the key rotation event are to be signed using the second key;
obtaining, in response to the second identification, the key rotation entry, the key rotation entry comprising:
a payload identifying the first key to indicate that the first key was a designated key prior to the key rotation event for signing the first set of log entries; and
a signature generated using the second key; and
adding the key rotation entry to the log.

3. The method of claim 2, further comprising:
obtaining a new log entry and signing the new log entry with the second key; and
adding the signed new log entry to the second set of the log entries.

4. The method of claim 3, wherein the first key is a first private key of a first public private key pair and the second key is a second private key of a second public private key pair.

5. The method of claim 4, wherein the second set of the log entries are verifiable using a second public key of the second public private key pair and the first set of the log entries are verifiable using a first public key of the first public private key pair.

6. The method of claim 5, wherein verifying the log comprises:
verifying, using the second public key, that each log entry of the second set of the log entries is signed using the second private key of the second public private key pair;
verifying, using the second public key, that the key rotation entry is signed using the second private key;
obtaining the first public key from the payload of the key rotation entry; and
verifying, using the first public key, that each log entry of the first set of the log entries is signed using the first private key of the first public private key pair.

7. The method of claim 6, wherein the log is truncated so that a portion of the log is removed thereby establishing a removed portion.

8. The method of claim 7, wherein the removed portion of the log comprises:
one or more log entries of the first set of the log entries.

9. The method of claim 7, wherein all log entries of the log that is truncated are verifiable based on the second key and the key rotation entry.

10. The method of claim 9, wherein the first public key is not known prior to verifying the log and using the key rotation entry.

11. A non-transitory machine-readable medium having instructions stored therein, which when executed by a processor, cause the processor to perform operations for managing a log comprising a plurality of log entries, the operations comprising:
making a first identification that the log is to be cryptographically verified, the log comprising:
a first set of log entries added to the log at a first point in time and signed with a first key;
a key rotation entry signed using a second key and indicating replacement of the first key with the second key for log security purposes; and
a second set of log entries added to the log at a second point in time and signed with the second key, the second point in time being after the first point in time;
verifying, in response to the first identification and using the second key, the log to obtain a verified log; and
providing computer-implemented services using the verified log.

12. The non-transitory machine-readable medium of claim 11, wherein the operations further comprise:
prior to making the identification:
making a second identification that a key rotation event has occurred for the log, the key rotation event indicating that the second key is to replace the first key and log entries added to the log at future points in time after the key rotation event are to be signed using the second key;
obtaining, in response to the second identification, the key rotation entry, the key rotation entry comprising:
a payload identifying the first key to indicate that the first key was a designated key prior to the key rotation event for signing the first set of log entries; and
a signature generated using the second key; and
adding the key rotation entry to the log.

13. The non-transitory machine-readable medium of claim 12, wherein the operations further comprise:
obtaining a new log entry and signing the new log entry with the second key; and
adding the signed new log entry to the second set of the log entries.

14. The non-transitory machine-readable medium of claim 11, wherein the first key is a first private key of a first public private key pair and the second key is a second private key of a second public private key pair.

15. The non-transitory machine-readable medium of claim 14, wherein the second set of the log entries are verifiable using a second public key of the second public private key pair and the first set of the log entries are verifiable using a first public key of the first public private key pair.

16. A data processing system, comprising:
a processor; and
a memory coupled to the processor to store instructions, which when executed by the processor, cause the processor to perform operations for managing a log comprising a plurality of log entries, the operations comprising:
making a first identification that the log is to be cryptographically verified, the log comprising:
a first set of log entries added to the log at a first point in time and signed with a first key;
a key rotation entry signed using a second key and indicating replacement of the first key with the second key for log security purposes; and
a second set of log entries added to the log at a second point in time and signed with the second key, the second point in time being after the first point in time;
verifying, in response to the first identification and using the second key, the log to obtain a verified log; and
providing computer-implemented services using the verified log.

17. The data processing system of claim 16, further comprising:
prior to making the identification:
making a second identification that a key rotation event has occurred for the log, the key rotation event indicating that the second key is to replace the first key and log entries added to the log at future points in time after the key rotation event are to be signed using the second key;
obtaining, in response to the second identification, the key rotation entry, the key rotation entry comprising:
a payload identifying the first key to indicate that the first key was a designated key prior to the key rotation event for signing the first set of log entries; and
a signature generated using the second key; and
adding the key rotation entry to the log.

18. The data processing system of claim 17, further comprising:
obtaining a new log entry and signing the new log entry with the second key; and
adding the signed new log entry to the second set of the log entries.

19. The data processing system of claim 16, wherein the first key is a first private key of a first public private key pair and the second key is a second private key of a second public private key pair.

20. The data processing system of claim 19, wherein the second set of the log entries are verifiable using a second public key of the second public private key pair and the first set of the log entries are verifiable using a first public key of the first public private key pair.
